(19) United States
(12) Patent Application Publication
(10) Pub. No.: US 2024/0367306 A1
(43) Pub. Date: Nov. 7, 2024

(54) Tool Handle

(71) Applicant: Snap-on Incorporated, Kenosha, WI (US)

(72) Inventors: Nicholas A. Gabbey, Mount Pleasant, WI (US); George R.R. Call, Kenosha, WI (US); Ryan J. Flynn, Lake Forest, IL (US)

(21) Appl. No.: 18/141,809

(22) Filed: May 1, 2023

(51) Int. Cl. B25G 1/10; B25B 23/00

(52) U.S. Cl. CPC B25G 1/102; B25B 23/0035

(57) ABSTRACT

A tool handle includes a body extending along a central axis between a head and a base, wherein the body is configured with a lobe tip at each intersection of a tri-lobed pattern. A tool handle also includes a pair of parallel flat surfaces corresponding to each lobe tip of the tri-lobed pattern and extending along the central axis. The tool handle further includes a convex surface formed between each of the lobe tips of the tri-lobed pattern, where the convex surface extends between one of the pair of parallel flat surfaces and another of the pair of parallel flat surfaces aligned between two adjacent lobe tips.

### BACKGROUND

Tool handles often reflect a compromise between providing a comfortable hand grip for a user and accepting high turning torques. Depending upon the application, some tool handles may be focused on either user comfort or allowing high torque applications.

### OVERVIEW

Embodiments described herein relate to a tool handle incorporating a external geometry configured to provide user comfort and allow for the application of large turning torques.

In a first embodiment, the tool handle includes a body extending along a central axis between a head and a base, wherein the body is configured with a lobe tip at each intersection of a tri-lobed pattern. The tool handle further includes a pair of parallel flat surfaces corresponding to each lobe tip of the tri-lobed pattern and extending along the central axis, and a convex surface formed between each of the lobe tips of the tri-lobed pattern, wherein the convex surface extends between one of the pair of parallel flat surfaces and another of the pair of parallel flat surfaces aligned between two adjacent lobe tips.

In an embodiment of the tool handle, the tri-lobed pattern substantially defines a Reuleaux triangle.

In an embodiment of the tool handle, the tri-lobed pattern includes three equidistant lobes arranged around the central axis.

In an embodiment of the tool handle, the three equidistant lobes are arranged 120 degrees apart relative to an axis of rotation.

In an embodiment of the tool handle, each of the pair of parallel flat surfaces extends substantially between the head and the base of the body.

In an embodiment of the tool handle further includes an internal square formed within the base, wherein the internal square extends along the central axis into the body.

In an embodiment of the tool handle, a first tip of the internal square is aligned with one of the lobe tips defines as part of the tri-lobed pattern.

In an embodiment of the tool handle, the tri-lobed pattern is arranged to accept a three fingered grip.

In an embodiment of the tool handle, the base defines a convex base.

In an embodiment of the tool handle, the convex base is sized to accept a palm of a hand.

In an embodiment of the tool handle, the tri-lobed pattern is configured to receive a regular hexagon tool.

In an embodiment of the tool handle, the pair of parallel flat surfaces are configured to engage the regular hexagon tool.

In an embodiment of the tool handle, the regular hexagon tool is a 19 mm internal hexagon.

In an embodiment of the tool handle, the central axis is an axis of rotation.

In an embodiment of the tool handle, the convex surface formed between each of the lobe tips reflects a constant width.

In an embodiment of the tool handle, each of the lobe tips bisects one pair of parallel flat surfaces.

In an embodiment of the tool handle, the pair of parallel flat surfaces extending along the central axis extend between the head and the base including a taper adjacent to the head.

In an embodiment of the tool handle, the convex surface extends between a first flat surface of the pair of parallel flat surfaces at a first lobe tip and a second flat surface of the pair of parallel flat surfaces at a second lobe tip.

In an embodiment of the tool handle, the body is a molded body formed about a support shaft.

In an embodiment of the tool handle, the body is a metal body, wherein the head of the metal body is configured with an internal hex socket.

In an embodiment of the tool handle, the body is configured to accept a hand-generated torque and a mechanically generated torque.

In an embodiment of the tool handle, the body is configured as a control knob.

In an embodiment of the tool handle, the body is formed as a molded part, wherein the molded part is formed by at least one of: an injection molded plastic, a cast plastic, and a machined plastic.

In an embodiment of the tool handle, the body is formed as an additive part, wherein the additive part is formed by at least one of: an fused deposition modeling process, a powder jet, a selective sintering process, and a stereolithography process.

In a second embodiment, a method includes providing a tool body extending along a central axis between a head and a base, wherein the tool body is configured with a lobe tip at each intersection of a tri-lobed pattern. The method further includes defining a convex surface formed between each of the lobe tips of the tri-lobed pattern provided in the tool body, and receiving at least one force adjacent to at least one of the lobe tips of the tri-lobed pattern, wherein the force is received by at least one of a pair of parallel flat surfaces corresponding to each lobe tip of the tri-lobed pattern and extending along the central axis, and wherein the convex surface extends between one of the pair of parallel flat surfaces and another of the pair of parallel flat surfaces aligned between two adjacent lobe tips.

In an embodiment, the method further includes that the head of the tool body is configured to receive a tool bit.

In an embodiment, the method further specifies that the head includes a collet configured to accept the tool bit.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIGS. 1A and 1B show a perspective view of a tool body in accordance with an example embodiment, and a cross-sectional view of the tool body along section line 1B-1B.

FIGS. 2A and 2B show a perspective view of a tool body in accordance with an example embodiment, and a cross-sectional view of the example tool body along section line 2B-2B.

FIG. 3 shows a plan view of the tool body clasped within a three finger grip in accordance with an example embodiment.

FIG. 4 shows a plan view of the tool body in accordance with an example embodiment cooperating with an internal hexagon.

FIG. 5 shows an exploded perspective view of a socket tool incorporating the tool body in accordance with an example embodiment.

FIG. 6 shows an assembled perspective view of the socket tool shown in FIG. 5.

FIG. 7 shows a plan view of a socket tool incorporating the tool body in accordance with an example embodiment.

FIG. 8 shows a perspective view of the socket tool shown in FIG. 7.

FIG. 9 shows a reverse perspective view of the socket tool shown in FIG. 7 incorporating an internal square as part of the tool body in accordance with an example embodiment.

FIG. 10 shows a perspective view of an extended socket tool incorporating the tool body in accordance with an example embodiment.

FIG. 11 shows a perspective view of a hand tool incorporating a formed handle in accordance with an example embodiment.

FIG. 12 shows a perspective view of a socket tool in accordance with an example embodiment configured to receive a hand torque.

FIG. 13 shows a perspective view of the socket tool shown in FIG. 11 configured to receive a mechanical torque.

The drawings are schematic and not necessarily to scale. In the drawings, similar symbols typically identify similar components, unless context dictates otherwise.

### DETAILED DESCRIPTION

### I. Introduction

This disclosure describes example embodiments for a tool handle. The example embodiments may be implemented as part of a socket, a bit driver, or other tool intended to engage fasteners. The example embodiments of the tool handle incorporate an external geometry configured to improve a hand grip and to facilitate imparting a turning torque without need of a traditional socket or bit driver handle/device. The disclosed and described external geometry additionally allows a traditional single or double hexagon socket or wrench geometry to engage external features to provide a mechanism turning torque.

The disclosed and described external geometry includes pointed lobes arranged about a central axis such as an axis of rotation. In the example embodiment, each of the pointed lobes of the external geometry is spaced 120° apart around the central axis. In another embodiment, each of the pointed lobes is spaced between 110° to 130° apart, so as to accommodate manufacturing variations. The external geometry further incorporates three pairs of parallel flats spaced around the tri-lobed pattern. For example, each of the pairs of parallel flats corresponds to one of the pointed lobe tips spaced 120° apart around the central axis. In an example embodiment, each of the pointed lobe tips bisects one of the pairs of parallel flats.

In an example embodiment, the tri-lobed pattern formed as part of the external geometry is configured such that each lobe tips of the tr-lobed pattern corresponds to three of the six points within a hexagonal cavity common to a standard socket. The disclosed external geometry including the tri-lobed pattern allows for a traditional three-point grip often employed to grip a writing utensil. In practice, a three-point grip or pencil grip may be accomplished by positioning the tool between the thumb and the pointer finger and supporting the tool by the middle finger. The disclosed and described external geometry further incorporates a convex radius is extending between flat surfaces formed between two adjacent lobe tips of the tri-lobed pattern that provides an engagement surface free of uncomfortable pressure points.

In an example embodiment, the disclosed and described external geometry includes an internal square oriented to align a point of the internal square with one of the lobed tips of the tri-lobed pattern to within 5° of true. The disclosed alignment between the internal square and one of the lobe tips optimizes the strength of the design by reducing the number of narrowed cross sections between the internal square vertices and the external surface of the tri-lobe pattern.

In an example embodiment, the disclosed and described external geometry may be implemented as part of tool such as a socket, bit bases, holders, and extensions. In an example embodiment, the tri-lobed pattern allows for sustained hand grip engagement providing rotational torque loads on the tool which increases the usability in scenarios not suitable for traditional socket/bit driver handles. The tri-lobed pattern including the radii providing a smooth transition between flat surfaces formed adjacent to each lobe tip also allows a user familiar with a three-point writing grip to grasp the tool without experiencing a potential pressure-point locations that would commonly be found in a hexagonal feature. The tri-lobed pattern includes six flats arranged in three sets of parallel planes positioned at 120° locations about the external geometry. In operation, the external geometry including the six flats may engage with a traditional single or double hexagonal fastener engagement tool, such as a socket or box-end wrench. In another example embodiment, the external geometry and the disclosed tri-lobed pattern decreases the propensity for a tool handle having a cylindrical profile to unwantedly roll when placed on an uneven surface.

### II. Example External Geometry for a Tool Handle

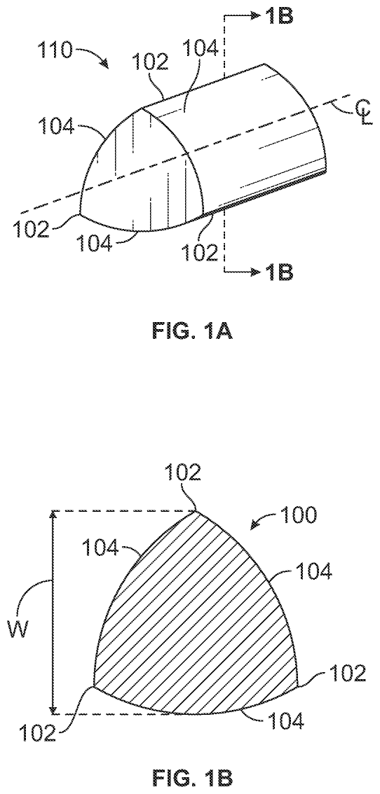

FIG. 1A shows an example embodiment of an external geometry 100 implemented as part of a tool handle 110. FIG. 1B shows a cross-sectional view of the tool handle 110 highlighting the symmetry of the external geometry 100. As illustrated in FIG. 1A, the tool handle 110 is symmetrical about a centerline CL. The external geometry 100 reflects a symmetrical pattern including three instances of a lobe tip 102 equally spaced about the circumference of the tool handle 110. The external geometry 110 further includes a radius 104 arranged to smoothly connect a first instance of a lobe tip 102 to a second instance of a lobe tip 102. As shown in FIG. 1B, each point of the radius 104 is a constant width w relative to a corresponding lobe tip 102.

The external geometry 100 of the shown embodiment reflects one example of a Reuleaux triangle or a curved triangle. The Reuleaux triangle or curved triangle is identified by the constant width w. As illustrated in FIG. 1B, constant width reflects that for every pair of parallel supporting lines one of the two lines will necessarily touch the Reuleaux triangle at one of its vertices, and the other line may touch the triangle at any point on the opposite arc, and their distance (the width of the Reuleaux triangle) equals the radius of this arc. As shown, this exemplary width equals the distance between the lobe tip 102 and any point along the radius 104 of the external geometry 100.

The example embodiment including the external geometry 100 provides for a reduced number of pressure points and allows for a comfortable user grip. The smooth and seamless constant width may make the hand application of rotational torque difficult.

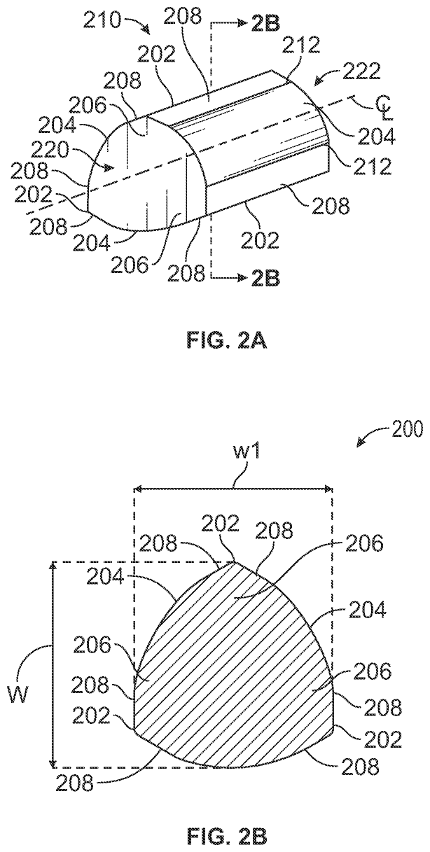

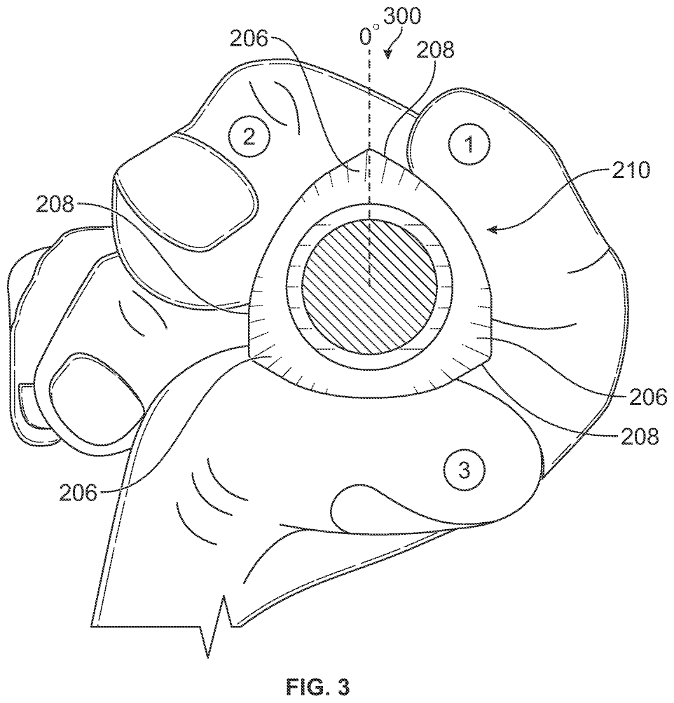

FIG. 2A shows an example embodiment of an external geometry 200 implemented as part of a tool handle 210. FIG. 2B shows a cross-sectional view of the tool handle 210 highlighting the flats integrated into the external geometry 200. As illustrated in FIG. 1A, the tool handle 210 is rotational about a centerline CL. The external geometry 200 reflects a symmetrical pattern including three lobes 206 terminating in instances of a lobe tip 202 equally spaced about the circumference of the tool handle 210. Each of the lobe tips 202 is arranged between a first flat surface 208 and a second flat surface 208 formed as part of each lobe 206. Accordingly, there are six flat surfaces 208 grouped into three pairs of flat surfaces arranged around the external geometry 200.

The external geometry 200 further includes a convex surface 204 extending between any two adjacent lobe tips 202. In particular, the convex surface 204 extends between a first edge 212 of a first flat surface 208 and a first edge 212 of the second flat surface 208. The convex surface 204 smoothly connects a first instance of a lobe tip 202 to a second instance of a lobe tip 202 while incorporating flats surfaces 208 adjacent to each of the lobe tips 202. As shown in FIG. 2B, the convex surface 204 reflects a constant width w relative to a corresponding lobe tip 202. Similarly the width w1 measured across parallel flat surfaces 208 may be sized to engage a traditional single or double hexagonal fastener engagement tool. For example, the width w1 may be sized to engage a standard nineteen millimeter (19 mm) internal hexagon common in many hand tools such as wrenches and sockets. The external geometry 200 including the width w1 across parallel flat surfaces 208 may be sized to interface and engage with tools that comply with the ASME B107.110 standard.

FIG. 2A further shows that the external geometry 200 extends between a first end 220 and a second end 222 to form the tool handle 210. The first end 220 may be the head or the front of the tool handle 210. The second end 222 may be the base or the end of the tool handle 210. In other words, the external geometry 200 is extruded along the centerline CL to form a structure without surface features to pinch or generate uncomfortable pressure points within a user's grasp. The first end 220 or head of the tool handle 210 may be configured to receive or support a tool. The second end 222 or base may be rounded or otherwise molded to comfortably fit into the palm of a user's hand. In some example embodiments, the tool handle 210 may be tapered, rounded, or otherwise curved to prevent and remove sharp angles adjacent to the head and the base.

FIG. 3 shows a bottom plan view of the tool handle 210 including the external geometry 200 engaged by a user in a traditional three fingered grip. As shown, each of the three lobes 206 allows a user to grip a tool handle 300 between the pointer finger (1), middle finger (2), and thumb (3) in a grip similar to one used to hold a writing instrument such as a pencil grip. In operation, the illustrated three finger grip allows a user to apply a rotational torque to the tool handle 210 when force is applied through the thumb (3) and pointer finger (1) engaging flat surfaces 208 adjacent to two lobes 206 defined as part of the external geometry 200.

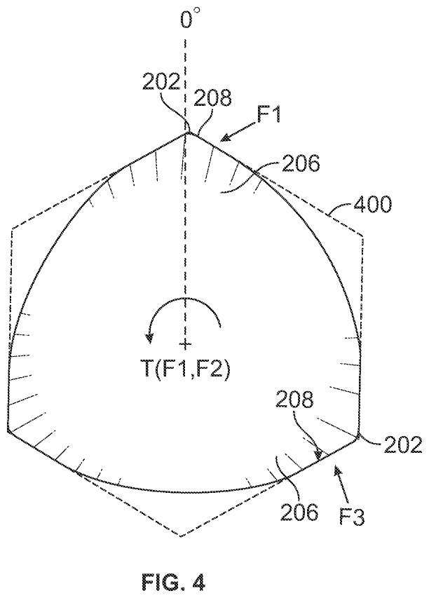

FIG. 4 shows a bottom plan view of the tool handle 210 including the external geometry 200 in response to force being applied as part of the traditional three fingered grip. As shown and discussed above, a force F1 applied by the pointer finger (1) and a force F3 applied by the thumb (3) results in the tool handle 210 rotating about the centerline CL with a torque T. In practice, the force F1 and the force F3 are applied substantially adjacent to flat surfaces 208 and lobe tip 202. In some embodiments, substantially adjacent indicates that the force F1 and the force F3 are applied perpendicular relative to the flat surface 208. In some embodiments, substantially adjacent indicates that the force F1 and the force F3 are applied against the flat surface 208. In some embodiments, substantially adjacent indicates that the force F1 and the force F3 are applied to the flat surface 208 adjacent to the lobe tip 202. In operation, the flat surface 208 receives the forces at a distance away from the centerline CL and the increased resulting moment arm causes the tool handle to rotate counterclockwise as shown in FIG. 4.

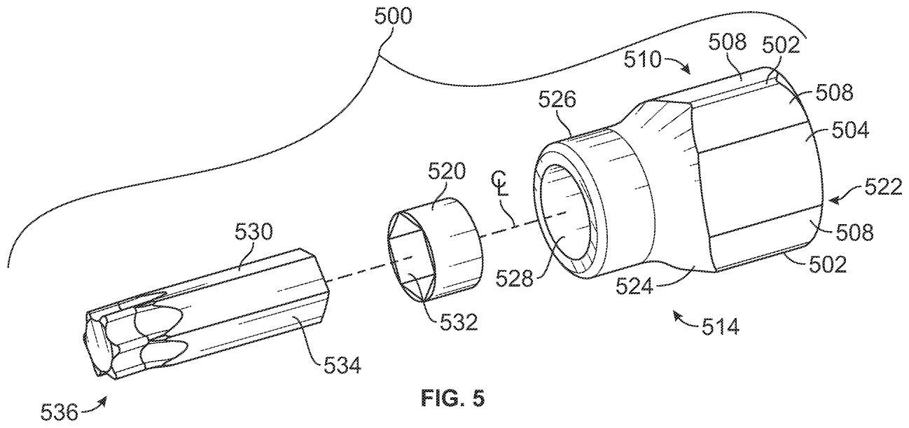

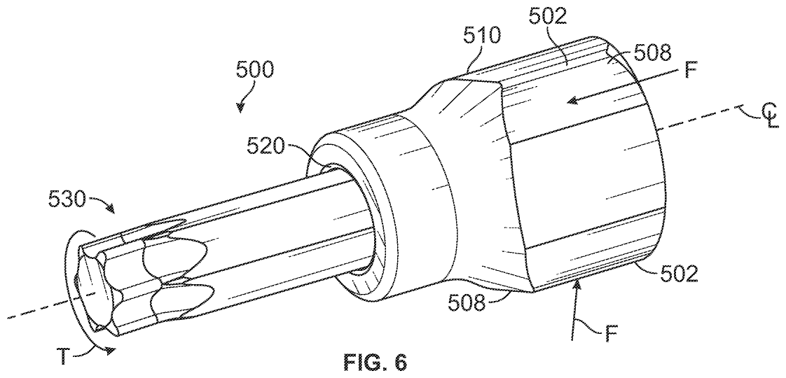

FIGS. 5 and 6 show the external geometry 200 implemented as a bit holder 500. FIG. 5 shows an exploded view of the bit holder 500 according to one example embodiment. FIG. 6 shows an assembled view of the bit holder 500 depicted in FIG. 5. As shown in FIG. 5, the bit holder 500 includes a handle 510 and a bit collet 520 configured to accept a tool bit 530.

The handle 510 includes an example of the external geometry 200 including three lobe tips 502 bisecting a first flat surface 508 and a second flat surface 508. The handle 510 further illustrates that a convex surface 504 smoothly connects a flat surface 508 associated with one lobe tip 502 to another flats surface 508 associated with an adjacent lobe tip 502.

The handle 510 extends along the centerline CL between a head 520 and a base 522. In this example embodiment, the base 522 is rounded, smoothed, and formed to engage the palm of a user without generating pressure points. In this example embodiment, the flat surfaces 508 extend substantially between the head 514 and the base 522. For example, extending substantially between the head 514 and the base 522 may not include the taper 524. In some example embodiments, extending substantially between the head 514 and the base 522 include part, but not all, of the body 510. The head 514 in this example embodiment includes a taper 524 that transitions from the external geometry 200 of the handle 510 to a substantially cylindrical tool mount 526 sized to accept the bit collet 520. In some embodiments, the substantially cylindrical tool mount 526 may be a smooth surface that prevents undesirable pressure points. In some embodiments, the substantially cylindrical tool mount 526 may include a flat surface sized to receive a corresponding flat surface provided in the bit collet 520 to prevent rotation. For example, the bit collet 520 could include a space 528 sized to accept the bit collet 520. The bit collet 520 may be slightly oversized relative to the space 528 which results in a press fit when mounted within the tool mount 526. In other example embodiments, the bit collet 520 may be formed or manufactured as an integral part of the head 514.

In one example embodiment, the bit collet 520 is cylindrical and includes an internal hexagon 532 configured to accept the tool bit 530. The bit collet 520 may be tapered or otherwise include a locking mechanism to secure and hold the tool bit 530. In some example embodiments, the internal hexagon 532 may be replaced with an internal square or other connection mechanism. In some example embodiments, the handle 510 may be used as valve handle or a control knob and the internal hexagon 532 may be replaced with tapped hole sized to accept a threaded shaft, or a threaded shaft for mounting an another device. Similarly, the tool bit 530 may have a first end 534 configured to engage with the internal hexagon 532. The first end 534 may be a threaded end, an external square or any other means of connecting to and securely engaging with the handle 510. The first end 534 may be configured to prevent rotation of the tool bit 530 relative to the handle 510 when the torque T is applied.

The tool bit 530 may have a second or working end 536 configured to engage with a variety of fasteners. The working end 536 may be a hexagon tool, a star or torx tool, screwdrivers or any other tool configuration.

FIG. 6 shows the bit holder 500 assembled to includes the bit collet 510 carried within the handle 510 and the bit collet 520 securely engages with the tool bit 530. As shown in FIG. 6, when one or more forces F are applied to the flat surfaces 508 adjacent to the lobe tips 502, the bit holder 510 rotates about the centerline CL to generate a torque T at the tool bit 530.

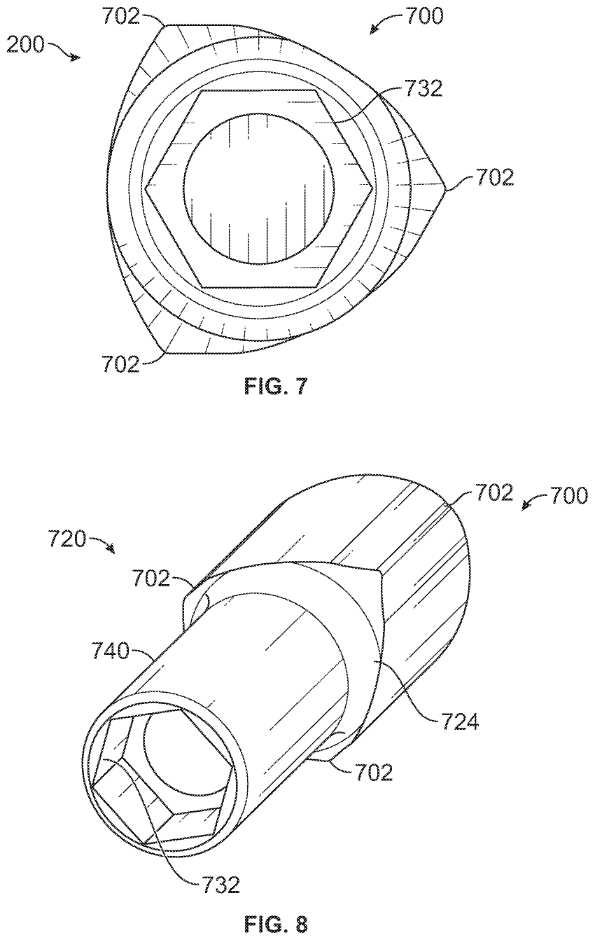

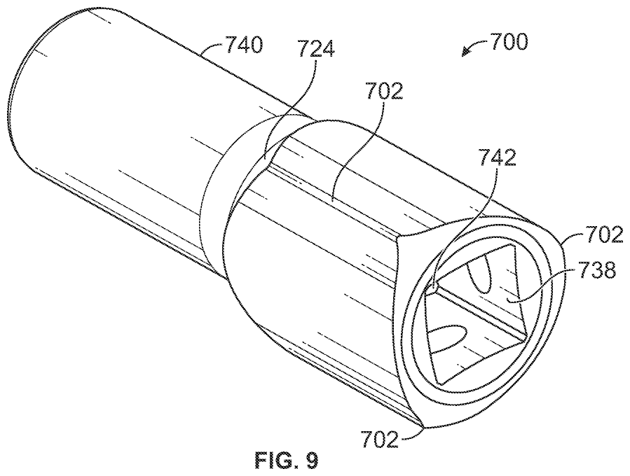

FIGS. 7-9 show an example embodiment of a tool 700 including both an internal hexagon 732 and an internal square 738. FIG. 7 shows a plan view of the tool 700 according to one example embodiment. FIG. 8 shows a front perspective view of the tool 700 showing the internal hexagon 732. FIG. 9 shows a reverse perspective view of the tool 700 showing an internal square 738. FIGS. 7 and 8 show the tool 700 including a handle 710 configured with three lobes 702 in a tri-lobed pattern according to the external geometry 200. As shown in FIG. 8, the handle 710 includes a taper 724 formed at a first end 722 and extending to a tool shank 740 configured to include the internal hexagon 732 such as one used in a socket. For example, the tool 700 may be one socket from a set of sockets where each of the internal hexagons 732 are configured in compliance with ASME B107.101 standard.

FIG. 9 shows that the tool 700 may interface and cooperate with a socket or bit driver utilizing the internal square 738 formed into the second end or back of the tool 700. For example, the internal square 738 may be oriented such that a point 742 of the square aligns with one of the lobe tips 702 of the tri-lobed pattern defined according to the external geometry 200. In an embodiment, the point 742 aligns with the lobe tip 702 to within five degrees (5°). The alignment between the internal square 738 and the lobe tip 702 optimizes the strength of the design by reducing the number of narrowed cross sections between the vertices of the internal square 702 and the external surface of the tool 700.

The tool 700 may be constructed from, for example, metal additive manufacturing or metal 3D printing. Metal additive manufacturing such as fused deposition modeling, powder jet, selective laser sintering, and stereolithography may be utilized to provide the external geometry 200 as part of the finished tool 700. Some metal materials and process examples include: metal sintering, metal injection molding, forging, various machining processes, direct metal laser sintering, and other forms of metal additive manufacturing like fused filament fabrication.

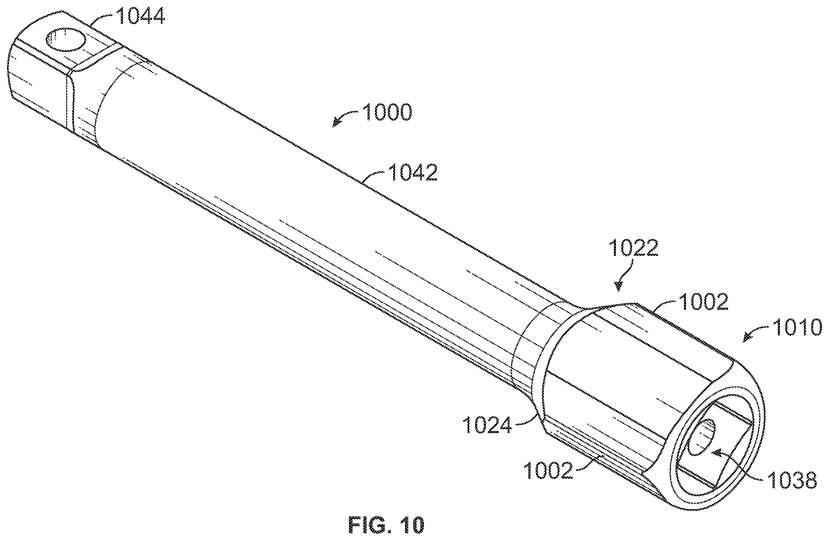

FIG. 10 shows a perspective view of an extended tool 1000 configured according to one example embodiment. The extended tool 1000 includes a handle 1010 configured with three lobes 1002 in a tri-lobed pattern according to the external geometry 200. The handle 1010 includes a taper 1024 formed at a first end 1022 and extending to a tool shaft 1042. The tool shaft 1042 may include or be formed with the external square 1044 and be configured to engage a socket or other tool. In another example embodiment, the external square 1044 may be replaced with an internal hexagon such as one used in a socket. For example, the tool 1000 may be one extended socket from a set of sockets where the first end of each socket include an internal hexagon configured in compliance with ASME B107.101 standard.

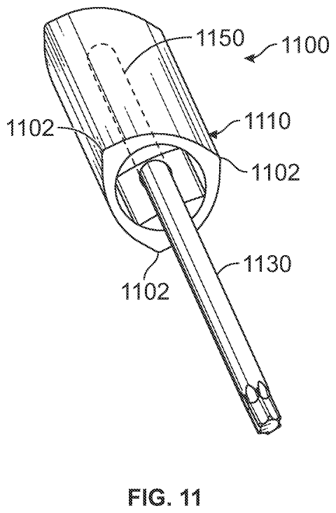

FIG. 11 shows a perspective view of a hand tool 1100 configured according to one example embodiment. The hand tool 1100 includes a handle 1110 configured with three lobes 1102 in a tri-lobed pattern according to the external geometry 200. In this example embodiment, the handle 1110 included as part of the hand tool 1100 is a molded handle. For example the handle 1110 may be formed over a support rod 1150. For example, the handle 1110 may be formed using injection molded plastics, cast plastics, and machined plastics. The support rod 1150 may reinforce the handle 1110 to prevent deflection when a force is applied by a user. The support rod 1150 may be an integral part of a tool bit 1130. Alternatively, the support rod 1150 may configured to removably accept the tool bit 1130 as discussed in connection with FIG. 5.

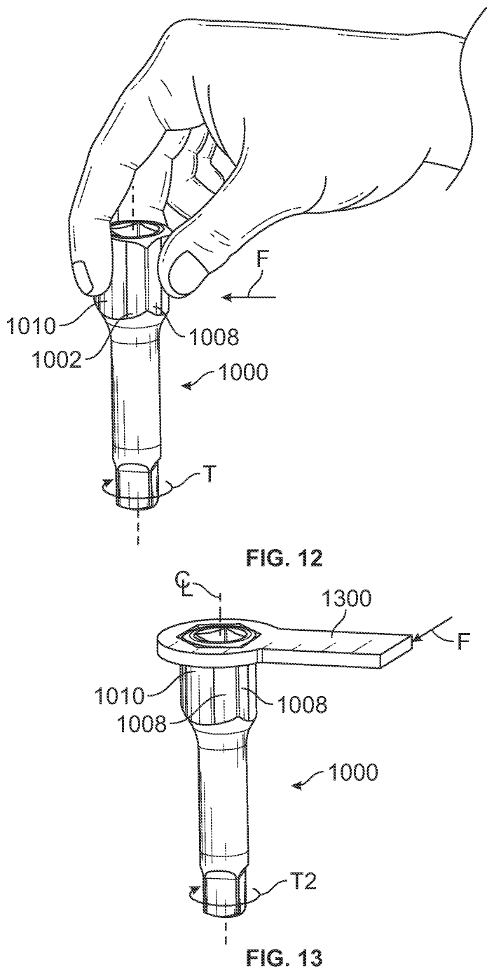

FIGS. 12 and 13 shows a perspective view of the extended tool 1000 in use. FIG. 12 shows that extended tool 1000 as grasped in a user's hand. FIG. 13 shows the extended tool 1000 cooperating with a lever 1300 such as a wrench to receive a mechanical force. FIG. 12 shows the user engaging the handle 1110 in a traditional three fingered grip. Specifically, FIG. 12 shows the thumb of a user's hand pressed against the flat surface 1008 formed adjacent to the lope tip 1002. The pressure provided by the thumb provides a force F to rotate the extended tool 1000 about the centerline CL in a clockwise direction according to the resulting torque T. By removing surface irregularities from the handle 1110, the user can apply significant force without experiencing painful pressure points. The lobe tips 1002 and associated flat surface 1008 provide a lever arm through which the provided force F may be transmitted to the tool 1000.

FIG. 13 shows an alternate configuration in which the lever 1300 is coupled to the extended tool 1000. The lever 1300 may be configured in compliance with ASME B107.101 standard and sized to cooperate with the handle 1110. As shown, the individual flats of the internal hexagon of the lever 1300 are aligned to and engaged with the flat surfaces 1008 adjacent to each of the lobe tip 1002. In this example embodiment, a mechanical advantage may be realized when a user applies the force F to the lever 1300. The pressure provided through the lever 1300 results in the rotation of the extended tool 1000 about the centerline CL in a counterclockwise direction according to the resulting torque T2. The alignment of the internal hexagon of the lever 1300 to the flat surfaces 1008 of the handle 1110 allows for a large force to be transmitted to the extended tool 100.

In an example embodiment, a tool handle includes a body extending along a central axis of rotation between a head and a base. The body may be configured with a lobe tip at each intersection of a tri-lobed pattern that incorporates a pair of parallel flat surfaces corresponding to each lobe tip of the tri-lobed pattern. For example, each lobe tip may bisect one of the pairs of parallel flat surfaces. Both the lobe tips and the parallel flats surfaces extending along the central axis and are smoothly coupled by a convex surface formed between each of the lobe tips of the tri-lobed pattern. The convex surface extends between one of the pair of parallel flat surfaces and another of the pair of parallel flat surfaces aligned between two adjacent lobe tips. The convex surface and the pair of parallel flat surfaces of the tri-lobed pattern substantially defines a Reuleaux triangle including a constant width relative to a lobe tip. In some embodiments, substantially defining a Reuleaux triangle includes the convex surface having a constant width relative to one of the lobe tips. In some embodiments, substantially defining a Reuleaux triangle includes the flat surfaces extending away from the lobe tips and smoothly coupled to the convex surfaces. For example, the convex surface extends between a first flat surface of the pair of parallel flat surfaces at a first lobe tip and a second flat surface of the pair of parallel flat surfaces at a second lobe tip.

The example tri-lobed pattern may include three equidistant lobes arranged around the central axis. The three equidistant lobes may be arranged 120 degrees apart relative to an axis of rotation. Similarly, the three pairs of parallel flat surfaces arranged about the central axis extend along the central axis between the head and the base of the body.

In an example embodiment, the tool handle may incorporate an internal square formed within the head, wherein the internal square extends along the central axis into the body. A first tip of the internal square may be aligned with one of the lobe tips defines as part of the tri-lobed pattern. The body and the tri-lobed pattern are configured to allow a user to grasp with a three finger grip such as a pencil grip.

In an example embodiment, the body of the tool may include a convex shape sized to fit comfortably in the palm of a user's hand.

In an example embodiment, the body including the tri-lobed pattern may be configured according to the ASME B107.101 standard such that it can receive, for example, a nineteen millimeter (19 mm) regular hexagon tool. For example, the parallel flat surfaces are configured to engage the regular hexagon tool. In some embodiments, the body may be a solid metallic body, a plastic body, or a mixed material body based on the intended use of the tool.

### IV. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a symptom.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. A tool handle comprising:
a body extending along a central axis between a head and a base, wherein the body is configured with a lobe tip at each intersection of a tri-lobed pattern;
a pair of parallel flat surfaces corresponding to each lobe tip of the tri-lobed pattern and extending along the central axis; and
a convex surface formed between each of the lobe tips of the tri-lobed pattern, wherein the convex surface extends between one of the pair of parallel flat surfaces and another of the pair of parallel flat surfaces aligned between two adjacent lobe tips.

2. The tool handle of claim 1, wherein the tri-lobed pattern substantially defines a Reuleaux triangle.

3. The tool handle of claim 1, wherein the tri-lobed pattern includes three, substantially equidistant lobes arranged around the central axis.

4. The tool handle of claim 3, wherein the three equidistant lobes are arranged substantially 120 degrees apart relative to an axis of rotation.

5. The tool handle of claim 1, wherein each of the pair of parallel flat surfaces extends substantially between the head and the base of the body.

6. The tool handle of claim 1 further comprising:
an internal square formed within the head, wherein the internal square extends along the central axis into the body.

7. The tool handle of claim 6, wherein a first tip of the internal square is aligned with one of the lobe tips defines as part of the tri-lobed pattern.

8. The tool handle of claim 1, wherein the tri-lobed pattern is arranged to accept a three finger grip.

9. The tool handle of claim 1, wherein the base defines a convex base.

10. The tool handle of claim 9, wherein the convex base is sized to accept a palm of a hand.

11. The tool handle of claim 1, wherein the tri-lobed pattern is configured to receive a regular hexagon tool.

12. The tool handle of claim 11, wherein the pair of parallel flat surfaces are configured to engage the regular hexagon tool.

13. The tool handle of claim 11, wherein the regular hexagon tool is a 19 mm internal hexagon.

14. The tool handle of claim 1, wherein the central axis is an axis of rotation.

15. The tool handle of claim 1, wherein the convex surface formed between each of the lobe tips reflects a constant width.

16. The tool handle of claim 1, wherein each of the lobe tips bisects one pair of parallel flat surfaces.

17. The tool handle of claim 1, the pair of parallel flat surfaces extending along the central axis extend between the head and the base including a taper adjacent to the head.

18. The tool handle of claim 1, wherein the convex surface extends between a first flat surface of the pair of parallel flat surfaces at a first lobe tip and a second flat surface of the pair of parallel flat surfaces at a second lobe tip.

19. The tool handle of claim 1, wherein the body is a molded body formed about a support shaft.

20. The tool handle of claim 1, wherein the body is a metal body, wherein the base of the metal body is configured to accept an internal hex socket.

21. A method comprising:
providing a tool body extending along a central axis between a head and a base, wherein the tool body is configured with a lobe tip at each intersection of a tri-lobed pattern;
defining a convex surface formed between each of the lobe tips of the tri-lobed pattern provided in the tool body;
receiving at least one force adjacent to at least one of the lobe tips of the tri-lobed pattern, wherein the force is received by at least one of a pair of parallel flat surfaces corresponding to each lobe tip of the tri-lobed pattern and extending along the central axis, and wherein the convex surface extends between one of the pair of parallel flat surfaces and another of the pair of parallel flat surfaces aligned between two adjacent lobe tips.

22. The method of claim 21, wherein the head is configured to receive a tool bit.

23. The method of claim 23, wherein the head includes a collet is configured to accept the tool bit.
